(19) United States
(12) Patent Application Publication
(10) Pub. No.: US 2002/0138914 A1
(43) Pub. Date: Oct. 3, 2002

(54) Tool head device adapted to be mounted on a hammer

(76) Inventor: Ming-Hsuan Lin, Taichung Hsien (TW)

Correspondence Address: CHRISTIE, PARKER & HALE, LLP, 350 WEST COLORADO BOULEVARD, SUITE 500, PASADENA, CA, 91105, US

(21) Appl. No.: 09/821,317

(22) Filed: Mar. 29, 2001

(51) Int. Cl. B25D 1/04

(52) U.S. Cl. 7/143

(57) ABSTRACT

A tool head device is adapted to be mounted on a head of a hammer, and includes an operating portion in the form of a hatchet or trowel blade, and a coupling portion formed integrally with and extending from the operating portion. The coupling portion has a concavity for inserting a bell portion of the head of the hammer, and an internally threaded wall for engaging threadedly a screw fastener so as to position releasably the coupling portion on the head of the hammer. The assembly of the tool head device and the hammer permits multiple operating functions.

### BACKGROUND OF THE INVENTION

1. Field of the Invention

This invention relates to an accessory of a hand tool, more particularly to a tool head device which is adapted to be mounted on a hammer so as to offer different operating functions.

2. Description of the Related Art

presently, a large number and variety of hand tools are required for use in different occasions for different operating functions. Thus, a large accommodating space is required to store these hand tools. It is inconvenient to carry the required hand tools outdoors, such as when camping.

### SUMMARY OF THE INVENTION

The object of the present invention is to provide a tool head device which is adapted to be mounted on a hand tool, such as a hammer, so as to offer different operating functions.

According to this invention, the tool head device includes an operating portion with an operating face which extends in a longitudinal direction parallel to a length of a hammer, and a coupling portion which is formed integrally with and which extends from the operating portion in a direction transverse to the longitudinal direction distal to the operating face. The coupling portion has an edge portion opposite to the operating face in the transverse direction, and an inner peripheral wall which extends from the edge portion in the transverse direction toward the operating portion and which terminates at an end wall so as to confine a concavity that is of such a dimension as to permit insertion of a bell portion of a head of the hammer in the transverse direction. At least one internally threaded wall extends in a radial direction relative to an axis of the bell portion to confine a threaded hole that is communicated with the concavity. At least one screw fastener engages threadedly the internally threaded wall, and has a tip end which extends into the concavity and which is adapted to abut against a neck portion and a shoulder of the head of the hammer so as to position the coupling portion on the head of the hammer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a partly sectional schematic view of a preferred embodiment of a tool head device according to this invention;

FIG. 2 is a partly sectional schematic view of the preferred embodiment when incorporated to a hammer; and

FIG. 3 is a partly sectional schematic view of another preferred embodiment of a tool head device according to this invention when incorporated to a hammer.

### DETAILED DESCRIPTION OF THE PREFERRED EMBODIMENTS

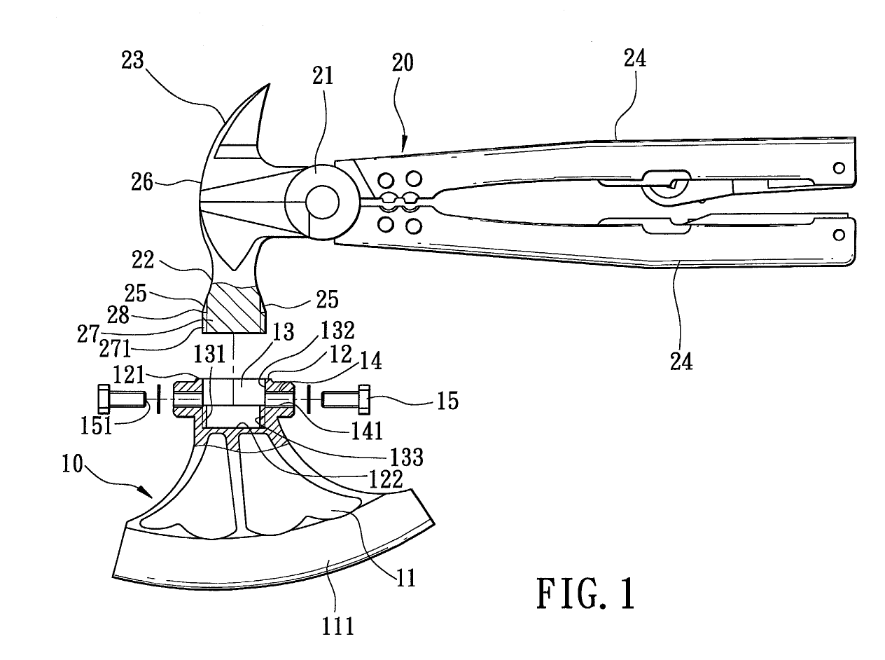

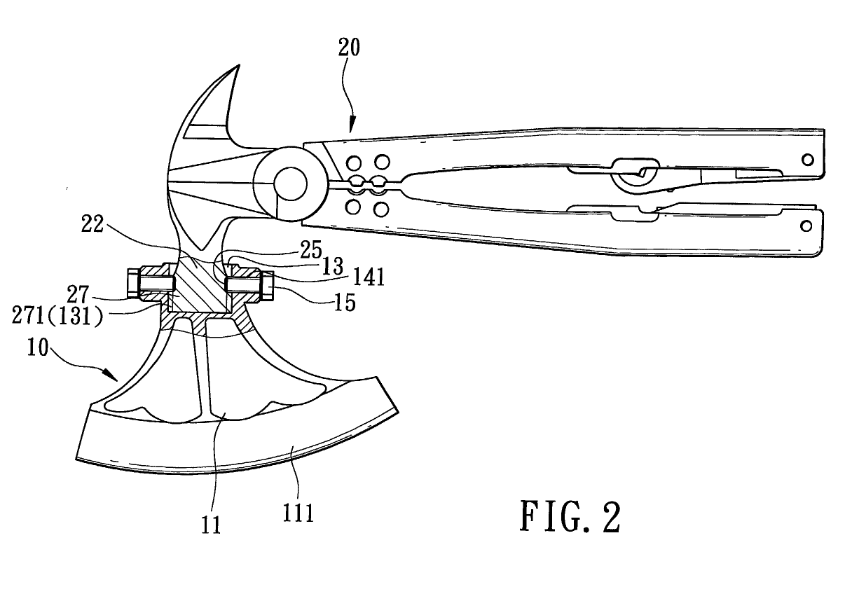

Referring to FIGS. 1 and 2, the preferred embodiment of the tool head device 10 according to the present invention is shown to be adapted to be mounted on a hammer 20. The hammer 10 includes two handles 24 which extend in a longitudinal direction, and a head 26 which is pivoted on ends of the handles 24 via a pivot portion 21. The head 26 includes a claw portion 23, a neck portion 22 which extends from the claw portion 23 in a direction transverse to the longitudinal direction, and a bell portion 27 which extends in the transverse direction from the neck portion 22 distal to the claw portion 23 to define an axis. The bell portion 27 has an outer diameter which is larger than that of the neck portion 22 so as to form a shoulder 28 at the juncture therebetween. Two inner abutment members are formed in the neck portion 22 adjacent to the shoulder 28, and are disposed opposite to each other in the longitudinal direction to confine two recesses 25. An externally threaded engaging portion 271 is disposed on the bell portion 27 and surrounds the axis.

The tool head device 10 of this embodiment is shown to comprise an operating portion 11 with an operating face 111 which extends in the longitudinal direction. In this embodiment, the operating portion 11 is formed as a hatchet blade with an edge to serve as the operating face 111. A coupling portion 12 is formed integrally with and extends from the operating portion 11 in the transverse direction distal to the operating face 111, and has an edge portion 121 opposite to the operating face 111 in the transverse direction. The coupling portion 12 includes an inner peripheral wall which extends from the edge portion 121 in the transverse direction toward the operating portion 11 and which terminates at an end wall 122 so as to confine a concavity 13 that is of such a dimension as to permit insertion of the bell portion 27 in the transverse direction. The inner peripheral wall includes proximate and distal wall segments 133, 132 respectively proximate and distal to the end wall 122 in the transverse direction. The proximate wall segment 133 has an internally threaded engaging portion 131 which surrounds the axis so as to engage threadedly the externally threaded engaging portion 271 when the bell portion 27 is inserted into the concavity 13.

The coupling portion 12 further includes two tubular ends 14 which are disposed opposite to each other in the longitudinal direction, and which have internally threaded walls 141 that extend in the longitudinal direction to confine two threaded holes that are communicated with the concavity 13.

Two screw fasteners 15 are disposed to engage threadedly the internally threaded walls 141, and have tip ends 151 which extend into the concavity 13 to be received and retained in the recesses 25 so as to position the coupling portion 12 on the head 26 of the hammer 20.

Therefore, the assembly of the hammer 20 and tool head device 10 can serve the functions of variety of hand tools, such as clamping pliers, a hammer, a claw, a hatchet, etc. It is especially convenient for use when camping and performing garden work.

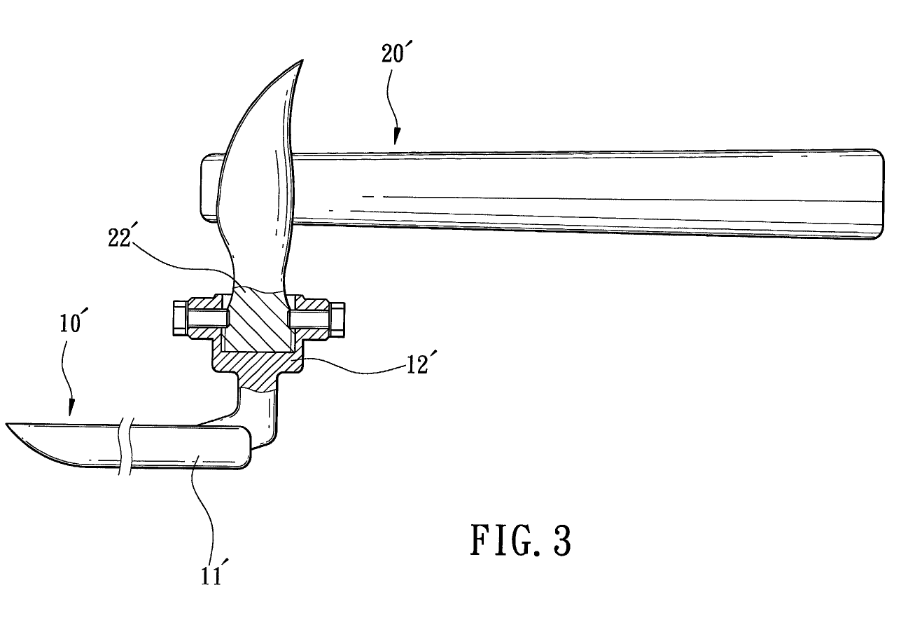

In this embodiment, since the recesses 25 and the internally threaded walls 141 are disposed to extend parallel to the handles 24 and the operating face 111, respectively, when the screw fasteners 15 engage threadedly the internally threaded walls 141 and extend into the recesses 25, the operating face 111 can be retained and positioned to be parallel to the handles 24 in the longitudinal direction. Referring to FIG. 3, another embodiment of the tool head device 10′ is shown to be similarly adapted to be mounted on a head 22′ of a hammer 20′. The tool head device 10′ includes a coupling portion 12′ which is similar to that of the previous embodiment in construction, and an operating portion 11′ which is formed as a trowel blade.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A tool head device adapted to be mounted on a hammer which includes a handle extending in a longitudinal direction, and a head secured to an end of the handle and including a neck portion extending from the end of the handle in a direction transverse to the longitudinal direction, and a bell portion extending outwardly and in the transverse direction from the neck portion to define an axis and having an outer diameter which is larger than that of the neck portion so as to form a shoulder at the juncture therebetween, said tool head device comprising:
an operating portion having an operating face extending in the longitudinal direction;
a coupling portion formed integrally with and extending from said operating portion in the transverse direction distal to said operating face, and having an edge portion opposite to said operating face in the transverse direction, said coupling portion including an inner peripheral wall which extends from said edge portion in the transverse direction toward said operating portion and which terminates at an end wall so as to confine a concavity that is of such a dimension as to permit insertion of the bell portion in the transverse direction, and at least one internally threaded wall which extends in a radial direction relative to the axis to confine a threaded hole that is communicated with said concavity; and
at least one screw fastener engaging threadedly said internally threaded wall, and having a tip end which extends into said concavity and which is adapted to abut against the neck portion and the shoulder so as to position said coupling portion on the head of the hammer.

2. The tool head device of claim 1, wherein said internally threaded wall extends in the longitudinal direction.

3. The tool head device of claim 1, wherein said inner peripheral wall includes proximate and distal wall segments respectively proximate and distal to said end wall in the transverse direction, and further comprising a threaded engaging member which includes an externally threaded engaging portion adapted to be disposed on the bell portion and to surround the axis, and an internally threaded engaging portion disposed on said proximate wall segment and surrounding the axis so as to engage threadedly the externally threaded engaging portion.

4. The tool head device of claim 1, further comprising an inner abutment member adapted to be formed and to extend in the neck portion in the radial direction to confine a recess so as to permit said tip end of said screw fastener to be received and retained in said recess.

5. The tool head device of claim 1, wherein said operating portion is formed with a hatchet blade with an edge that forms said operating face.

6. The tool head device of claim 1, wherein said operating portion is formed with a trowel blade with an edge that forms said operating face.
